(19) United States
(12) Patent Application Publication
(10) Pub. No.: US 2014/0097139 A1
(43) Pub. Date: Apr. 10, 2014

(54) SOLID PHASE EXTRACTION DISK HOLDER APPARATUS

(71) Applicant: Robert S. JOHNSON, Hampstead, NH (US)

(72) Inventor: Robert S. JOHNSON, Hampstead, NH (US)

(21) Appl. No.: 14/046,508

(22) Filed: Oct. 4, 2013

Related U.S. Application Data
(60) Provisional application No. 61/710,522, filed on Oct. 5, 2012.

(51) Int. Cl. G01N 1/40

(52) U.S. Cl. CPC G01N 1/405
USPC 210/656; 210/198.2

(57) ABSTRACT

Solid phase extraction (SPE) disks provide the greatest extraction efficiency when the maximum surface area of the disk is exposed to the sample. Such may be accomplished with the present disclosure wherein an SPE disk is secured within a cavity of a disk holder apparatus such that the SPE disk compresses against a side wall defining the cavity and forms a seal therebetween. The disk holder apparatus may be used in an open design for vacuum applications, or in a sealed design with a closure, when using positive pressure to force the sample through the disk. Examples of various configurations for the disk holder apparatus and methods of use are provided.

### CROSS-REFERENCE TO RELATED APPLICATIONS

The present application claims the benefit of the filing date of U.S. Provisional Application Ser. No., filed 61/710,522, filed Oct. 5, 2012, the teachings of which are incorporated herein by reference.

### FIELD

This disclosure relates generally to sample testing products and techniques, and more particularly to improved solid phase extraction (SPE) filtration disk holders and methods for their design and manufacture.

### BACKGROUND

In the art which can be described as separation science, means are provided for isolating, separating, and analyzing mixtures of solutions by selective adsorption on materials such as nylon, alumina, silica, bonded silica, polymers, and various other materials. The process is based on differences in the distribution ratios of the components of mixtures between a mutually immiscible mobile and a fixed stationary phase.

Solid phase extraction (SPE) is a laboratory technique for analyzing liquid and mixed liquid/solid samples. The basic objective of such apparatus is to filter the liquid sample and to selectively adsorb compounds or analytes from the liquid portion onto a sorbent. Using the appropriate solvent, the analytes of interest can be subsequently extracted from the sorbent and eluted into a collection vessel.

### SUMMARY

Conventional solid phase extraction (SPE) filtration disk holder apparatus comprise a mechanism, whereby the SPE disk is clamped, or otherwise firmly held between, an upper and a lower assembly. The lower assembly may consist of a flat annular surface, or basin to hold the disk, while the upper assembly may consist of a reservoir or collar to seal on a top perimeter surface edge area of the SPE disk. By clamping or pinching the upper and lower assemblies on the top and bottom perimeter edge areas of the SPE disk together, and sandwiching against the SPE disk there between, a perimeter of the SPE disk may be held in place, while a center area portion of the disk remains exposed for a sample to pass through.

As vacuum or positive pressure (i.e. pressure greater than atmospheric pressure) may be used to either pull or push a fluid sample (e.g. liquid such as water) through the SPE disk, it is necessary to provide an adequate seal between the disk holder assembly and the SPE disk. Any leakage of the sample, or air around the perimeter of the disk will result in low and inconsistent recoveries.

However, by pinching the SPE disk on the top and bottom perimeter edge areas to ensure a leak tight seal, the area under the pinch point becomes an area where analytes may become trapped, and/or are not removed or extracted during the elution step. With conventional disk holders, this phenomenon is present if either vacuum or positive pressure is used to move the liquid through the SPE disk.

In order to solve this problem and better ensure the best recoveries possible, the apparatus design presented herein provides an SPE disk to be compressed and press fit into the basin, such that the SPE disk forms a seal, particularly a press-fit seal, between the outer edge of the SPE disk, along the thickness of the SPE disk, and the inner basin wall. The SPE disk best suited for this press fit seal, which may also referred to as an interference fit or friction fit seal, should be on the order of 3 to 10 mm thick and of a resilient construction to allow the disk to elastically compress or flex as to be pressed into position, but still remain rigid, particularly as not to substantially deform (e.g. sag) or under the weight of the sample.

With the SPE disk pressed into position, the thickness edge of the SPE disk forms a compression seal with the surrounding basin walls and causes the fluid sample to flow through the SPE disk, and not around the edge of the SPE disk. A basin closure of the apparatus may be threaded onto the basin and be particularly configured not to make contact with the top surface of the SPE disk. An O-ring on the basin closure may provide a seal between the basin and top sealing member. By not making contact with the top surface of the SPE disk, there is no chance of analytes being trapped in a pinched area. Examples of various constructions for holding the SPE disk are provided.

### BRIEF DESCRIPTION OF THE DRAWINGS

The objects, features and advantages of the present invention will be apparent in the following detailed description thereof when read in conjunction with the appended drawings wherein the same reference numerals denote the same or similar parts throughout the several views.

FIG. 1 is an unassembled cross sectional side view of a conventional SPE disk holder apparatus;

FIG. 2 is an assembled cross sectional side view of a conventional SPE disk holder apparatus;

FIG. 3 is a cross sectional side view of sample flow through the assembled conventional SPE disk holder apparatus of FIGS. 1 and 2, particularly showing a flow of a fluid sample through a membrane of the SPE disk;

FIG. 4 is a perspective view of an exemplary SPE disk holder apparatus in accordance with the present disclosure;

FIG. 5 is a cross sectional side view of the SPE disk holder of FIG. 4 with a gasket separate from the a top sealing member;

FIG. 6 is the cross sectional side view of the SPE disk holder of FIG. 5 with a gasket joined to the top sealing member; and

FIG. 7 is a cross sectional side view of sample flow through the assembled SPE disk holder apparatus of FIGS. 4-6, particularly showing a flow of a fluid sample through a membrane of the SPE disk.

### DETAILED DESCRIPTION

It may be appreciated that the present disclosure is not limited in its application to the details of construction and the arrangement of components set forth in the following description or illustrated in the drawings. The embodiments herein may be capable of other embodiments and of being practiced or of being carried out in various ways. Also, it may be appreciated that the phraseology and terminology used herein is for the purpose of description and should not be regarded as limiting.

Referring now to FIG. 1, there is shown an unassembled, conventional SPE disk holder apparatus (2) to sandwich a sorbent-impregnated SPE disk (20) between an upper funnel or reservoir (25) and a lower basin (10). In this example, a support screen (15) is inserted into the basin (10), on top of which, is laid the SPE disk (20). The reservoir (25), typically glass with a flat, ground glass foot (27) is laid on top of the upper surface of the SPE disk (20), and the reservoir (25) is secured to the basin (10) with some type of clamp (30). In this example, the clamp (30) is a threaded collar that secures the reservoir (25) to the basin (10).

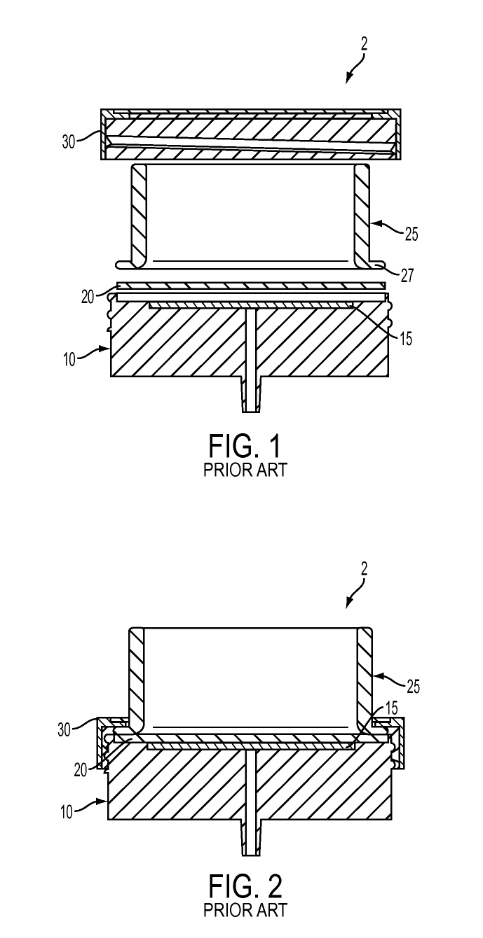

Referring now to FIG. 2, there is shown the assembled components of the SPE disk holder apparatus (2) of FIG. 1, as it would be when in use. As shown, by clamping or pinching the upper reservoir (25) and lower basin (10) on the top and bottom perimeter edge areas of the SPE disk (20) together, and sandwiching against the SPE disk (20) there between, a perimeter of the SPE disk (20) may be held in place, while a center area portion of the disk (20) remains exposed for a sample to pass through.

A fluid sample (e.g. liquid such as water containing analytes) may then be poured into the upper reservoir (25), and a vacuum source applied through the basin (10) to draw the sample through the sorbent of the SPE disk (20). This process may be continued until the entire sample to be filtered has passed through the disk/sorbent (20).

The analytes bound by the sorbents and trapped in solids filtered out by the SPE disk (20) may be collected by elution. The vacuum may be disconnected and a small amount of extraction solvent applied. The procedure may include a soak period, such that the analytes bound by the sorbents within the SPE disk (20), and on any particulate matter, desorb and partition into the extraction solvent. After soaking, vacuum may be reapplied, and the solvent collected.

To ensure the most effective interaction between the sample and the SPE disk (20), the SPE disk (20) must be supported in such a way that all the sample can pass freely through the entire SPE packing (sorbent) material, such that all analytes of interest have the potential to be retained in the SPE (sorbent) packing. It is very important that the disk holder apparatus (2) not interfere and prevent the sample and eluting solvent from reaching and extracting from all areas of the SPE disk (20). With the conventional method of sealing on the edge of the SPE disk (20), this is not possible. Any pinched, or clamped area of the SPE disk (20) becomes an upswept area, that can result in random and inconsistent recoveries.

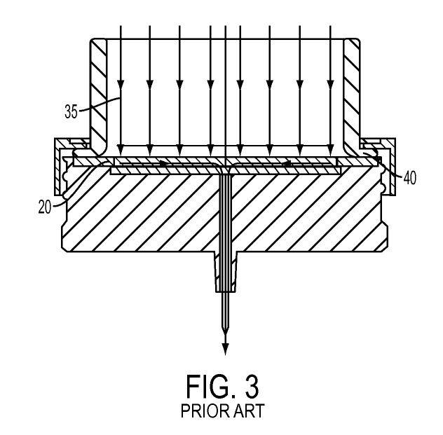

Referring now to FIG. 3, there is shown a flow of a sample or eluting solvent (35) through the SPE disk (20). While the sample and eluting solvent can freely pass through the center of the disk, the edges of the disk which are pinched by the basin (10) and the reservoir (25), create an upswept area (40) where sample can be retained, and/or not eluted during the elution step. Once the analytes are in this area, it is very difficult to remove, or extract them from the SPE disk (20). This phenomena can be easily seen, when the fluid sample is tinted with a food color dye, and is filtered through the SPE disk (20). As the sample filters through the SPE disk (20), the food color will be retained by the SPE sorbent. Once the entire sample is through the SPE disk (20), the SPE disk (20) is eluted with the appropriate solvent. The retained food color is eluted off and collected. However, when the disk holder apparatus (2) is disassembled and the SPE disk (20) examined, distinct coloration will be seen around the entire perimeter of the SPE disk (20)—that unswept area (40) which has been clamped between the two sealing surfaces. Any residual color is an indication that traces of the analytes of interest in the sample will be retained in this clamped area, resulting in erroneous reported values.

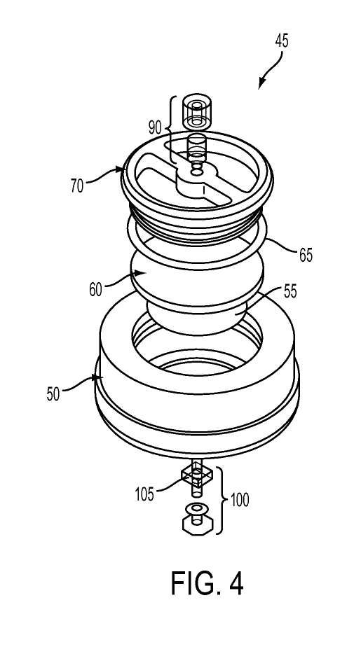

Referring now to FIGS. 4-6, there is shown an unassembled perspective and cross-sectional side views of a sealable solid phase extraction (SPE) filtration disk holder apparatus (45) according to the present disclosure. Generally, the inner diameter of the basin (50) is about 50 mm, and the outer diameter of the basin is 75 mm. However, these dimensions may change based on the diameter of the SPE disk (60) to be used. The basin wall thickness should be sufficiently thick to withstand positive pressure applied to the apparatus (45) without deformation. The depth of the inner cavity (52) of the basin (50) can also vary, but generally may be between 10 mm to 40 mm deep. The depth may vary based on the amount of internal volume desired when working with fluid samples (e.g. dirty/contaminated liquid such as water). The deeper the cavity (52), the more particulate matter can be accumulated on the surface of the SPE disk (60).

A support screen (55) may be placed in the bottom of the basin (50) and the screen (55) may be held in place by a recess (54) in the bottom of the basin (50). An SPE disk (60) is placed into the basin (50), and firmly pressed down on the edge (62) until the SPE disk (60) resides flat on top of the support screen (55). The design of apparatus (45) permits the SPE disk (60) to be press fit into the basin (50), such that the SPE disk (60) forms a friction seal between the outer thickness edge (62) of the SPE disk (60), along the thickness of the SPE disk (60), and the surface (58) of the inner basin wall. The SPE disk (60) best suited for this press fit seal, which may also be known as an interference fit seal, should be on the order of 3 to 10 mm thick and of a resilient construction to allow the SPE disk (60) to elastically compress or flex as to be pressed into position, but still remain rigid, particularly as not to substantially deform (e.g. sag) or under the weight of the sample. It should be understood that a press or interference fit may be created when an outer length dimension of the SPE disk (e.g. outer diameter) is greater than an inner length dimension of the basin wall (e.g. inner diameter), and the outer length dimension of the SPE disk (e.g. outer diameter) is then compressed to equal an inner length dimension of the basin wall (e.g. inner diameter). With the SPE disk (60) pressed into position, the thickness edge (62) of the SPE disk (60) forms a seal with the surrounding basin walls (58) and causes the fluid sample to flow through the SPE disk (60), and not around the edge (62) of the SPE disk (60).

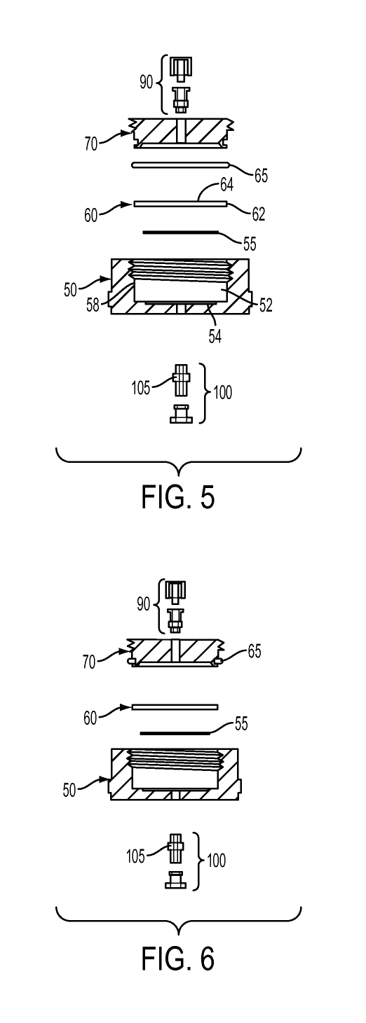

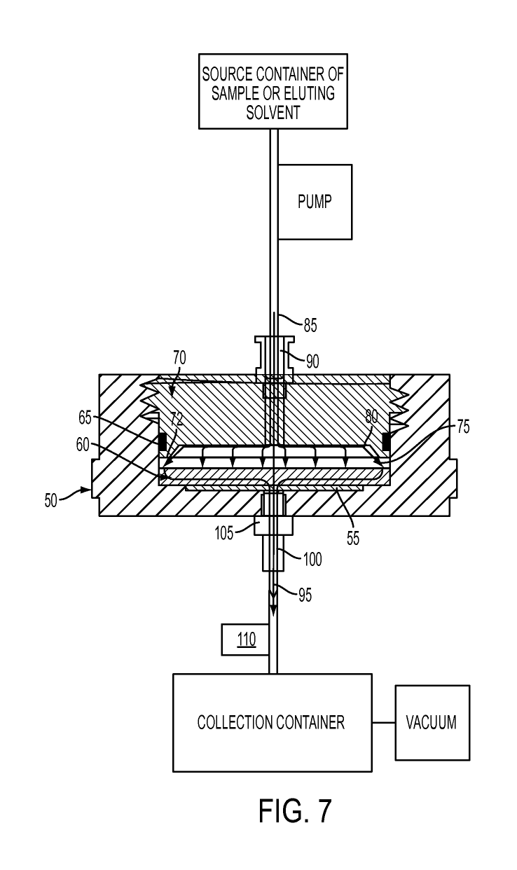

As best shown in FIGS. 6 and 7, the basin closure (70) or top seal includes a sealing O-ring (65). The external threads of the basin closure (70) may be is threaded into the internal threads of the basin (50), until the O-ring (65) engages the side walls (58) of the basin (50) and the seal is made. In FIG. 5, the O-ring (65) is shown separated from the basin closure (70). In actual use, the O-ring (65) fits into a circular groove (66) on the bottom end of the basin closure (70). When the basin closure (70) is inserted into the basin (50), the O-ring (65) provides a leak tight seal between the two parts, but leaves a fluid passage/gap (75) between the top surface (64) of the SPE disk (60) and the bottom edge (72) of the basin closure (70). As such, the top surface (64) of the SPE disk (60) will completely exposed to the fluid sample or eluting solvent. Luer fittings 90, 100 on the top and bottom of the apparatus (45) allow flexible tubing inlet and outlet fluid connecting lines (85, 95), to be detachably connected, respectively, such that liquid can be pulled by vacuum, or delivered by positive pressure (e.g. peristaltic pump) to the apparatus (45). If only vacuum is to be used with this design, than only the basin (70), the support screen (55), and the SPE disk (60) may be needed. The luer fitting (100) on the bottom of the basin (70) is attached to the appropriate vacuum line, and the sample processed as normal.

The basin may also contain a valve (105) to open and close the fluid passage exiting apparatus (45) such as a solenoid valve, or a clamp (110) (e.g. roller clamp) may be placed on the tubing (95). In this manner, with the valve (105) or clamp (110) closed, the solvent can be driven in to the cavity (52) and SPE disk (60) under pressure, and be forced into all exposed areas of the SPE disk (60). This may better ensure that a thorough extraction takes place. Pressures within the apparatus (45) may be in a range from 1 psi. to 100 psi. with a peristaltic pump, and more particularly be in a range of 1 psi. to 20 psi.

FIG. 7 shows the completely assembled apparatus (45). The O-ring (65) is used to provide a leak tight seal between the basin (50) and the basin closure (70). Just below the basin closure (70) is fluid passage/gap (75). Fluid passage/gap (75) can be of any reasonable dimension, so various prefilters, or filtering aids can be used in the apparatus (45). More importantly, the surface (64) of the SPE disk (60) is not pinched or clamped, meaning that there will be no upswept areas where analytes of interest could be trapped and not eluted off the disk (60) during the elution step. Using the same food color test as indicated above, no coloration is left on the SPE disk (60). The flow of sample and eluting solvent through the SPE disk (60) is depicted by the flow arrows (80), and indicate that the flow of liquid is through the entire SPE disk (60).

It should be noted that the size of the cavity (52) containing the SPE disk (60), as well as the size of the fluid passage/gap (75), may be adjusted based on the amount of threaded engagement between the basin closure (70) and the basin (50), such as by rotating the basin closure (70) further into engagement with the basin (50) to decrease the size (height) of the cavity (52) and the fluid passage/gap (75) or vice versa. In this manner, SPE disks (60) of different thickness may be accommodated.

According to one embodiment of the disclosure, a solid phase extraction system may comprise a solid phase extraction disk having a thickness; a solid phase extraction disk holder apparatus; wherein the solid phase extraction disk holder apparatus comprises a basin having a cavity to receive the solid phase extraction disk, the cavity defined by a bottom wall and an adjoining side wall; and wherein the solid phase extraction disk, when in the cavity, compresses against the side wall of the basin to form a seal, particularly a press fit seal, with the side wall of the basin.

According to other embodiments of the disclosure, the press fit seal may be formed along the thickness of the solid phase extraction disk.

According to other embodiments of the disclosure, the cavity of the basin may form a reservoir to contain a fluid sample which is to flow through the solid phase extraction disk; and the seal may inhibit the fluid sample from flowing between the solid phase extraction disk and the side wall of the cavity.

According to other embodiments of the disclosure, the bottom wall of the basin may include a fluid outlet for the fluid sample.

According to other embodiments of the disclosure, a screen may be located between the solid phase extraction disk and the bottom wall of the cavity.

According to other embodiments of the disclosure, the basin may include a recess in the bottom wall to receive the screen

According to other embodiments of the disclosure, a basin closure which covers the cavity may be provided as part of the system.

According to other embodiments of the disclosure, the basin closure may mechanically connect with the basin.

According to other embodiments of the disclosure, the basin closure may mechanically connect with the basin by threaded engagement.

According to other embodiments of the disclosure, the threaded engagement may be formed by external threads of the basin closure engaging with internal threads of the basin.

According to other embodiments of the disclosure, the basin closure may include a fluid inlet for a fluid sample which is to flow through the solid phase extraction disk.

According to other embodiments of the disclosure, a gasket may provide a seal between the basin closure and basin to inhibit leakage of a fluid sample located in the cavity.

According to other embodiments of the disclosure, the gasket may comprise an O-ring gasket located between a side wall of the basin closure and the side wall of the basin.

According to other embodiments of the disclosure, the O-ring gasket may be located in a groove formed in the side wall of the basin closure.

According to other embodiments of the disclosure, the basin closure, when connected to the basin, may be separated from the solid phase extraction disk in the cavity by a separation gap which provides a fluid flow passage for a fluid sample.

According to other embodiments of the disclosure a method of using a solid phase extraction system may comprise inserting a solid phase extraction disk into a cavity of a basin of a solid phase extraction disk holder apparatus such that the solid phase extraction disk compresses against a side wall of the basin and a seal is formed with the side wall of the basin which inhibits a fluid sample from flowing between the solid phase extraction disk and the side wall of the basin.

According to other embodiments of the disclosure, the method may further comprise introducing the fluid sample onto the solid phase extraction disk within the cavity which flows through the solid phase extraction disk to a fluid outlet without flowing between the solid phase extraction disk and the side wall of the basin.

According to other embodiments of the disclosure, the fluid sample flows through the solid phase extraction disk in a presence of at least one of positive pressure and vacuum.

According to other embodiments of the disclosure, the method may further comprise introducing an eluting solvent onto the solid phase extraction disk within the cavity which flows through the solid phase extraction disk to the fluid outlet without flowing between the solid phase extraction disk and the side wall of the basin.

According to other embodiments of the disclosure, the method may further comprise mechanically connecting a basin closure to the basin; forming a seal between the basin closure and the basin; and arranging the basin closure, when connected to the basin, such that a separation gap exists between a top surface of the solid phase extraction disk and the basin closure and the basin closure does not make contact with the top surface of the solid phase extraction disk.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A solid phase extraction system comprising:
a solid phase extraction disk having a thickness;
a solid phase extraction disk holder apparatus;
wherein the solid phase extraction disk holder apparatus comprises a basin having a cavity to receive the solid phase extraction disk, the cavity defined by a bottom wall and an adjoining side wall of the basin; and
wherein the solid phase extraction disk, when in the cavity, compresses against the side wall of the basin.

2. The solid phase extraction system of claim 1, wherein:
the solid phase extraction disk forms a seal with the side wall of the basin.

3. The solid phase extraction system of claim 1, wherein:
the cavity of the basin forms a reservoir to contain a fluid sample which is to flow through the solid phase extraction disk; and
the seal inhibits the fluid sample from flowing between the solid phase extraction disk and the side wall of the basin.

4. The solid phase extraction system of claim 3 wherein:
the bottom wall of the basin includes a fluid outlet for the fluid sample.

5. The solid phase extraction system of claim 1 further comprising:
a screen located between the solid phase extraction disk and the bottom wall of the cavity.

6. The solid phase extraction system of claim 5 wherein:
the basin includes a recess in the bottom wall to receive the screen

7. The solid phase extraction system of claim 1 further comprising:
a basin closure which covers the cavity.

8. The solid phase extraction system of claim 7 wherein:
the basin closure mechanically connects with the basin.

9. The solid phase extraction system of claim 8 wherein:
the basin closure mechanically connects with the basin by threaded engagement.

10. The solid phase extraction system of claim 9 wherein:
the threaded engagement may be formed by external threads of the basin closure engaging with internal threads of the basin.

11. The solid phase extraction system of claim 7 wherein:
the basin closure includes a fluid inlet for a fluid sample which is to flow through the solid phase extraction disk.

12. The solid phase extraction system of claim 7 further comprising:
a gasket which provides a seal between the basin closure and basin to inhibit leakage of a fluid sample located in the cavity.

13. The solid phase extraction system of claim 12 wherein:
the gasket comprises an O-ring gasket located between a side wall of the basin closure and the side wall of the basin.

14. The solid phase extraction system of claim 13 wherein:
the O-ring gasket is located in a groove formed in the side wall of the basin closure.

15. The solid phase extraction system of claim 7 wherein:
the basin closure, when connected to the basin, is separated from the solid phase extraction disk in the cavity by a separation gap which provides a fluid flow passage for a fluid sample.

16. A method of using a solid phase extraction system comprising:
inserting a solid phase extraction disk into a cavity of a basin of a solid phase extraction disk holder apparatus such that the solid phase extraction disk compresses against a side wall of the basin and a seal is formed with the side wall of the basin which inhibits a fluid sample from flowing between the solid phase extraction disk and the side wall of the basin.

17. The method of claim 16 further comprising:
introducing the fluid sample onto the solid phase extraction disk within the cavity which flows through the solid phase extraction disk to a fluid outlet without flowing between the solid phase extraction disk and the side wall of the basin.

18. The method of claim 17 wherein:
the fluid sample flows through the solid phase extraction disk in a presence of at least one of positive pressure and vacuum.

19. The method of claim 17 further comprising:
introducing an eluting solvent onto the solid phase extraction disk within the cavity which flows through the solid phase extraction disk to the fluid outlet without flowing between the solid phase extraction disk and the side wall of the basin.

20. The method of claim 16 further comprising:
mechanically connecting a basin closure to the basin;
forming a seal between the basin closure and the basin; and
arranging the basin closure, when connected to the basin, such that a separation gap exists between a top surface of the solid phase extraction disk and the basin closure and the basin closure does not make contact with the top surface of the solid phase extraction disk.
